(19) United States
(12) Patent Application Publication
(10) Pub. No.: US 2025/0189339 A1
(43) Pub. Date: Jun. 12, 2025

(54) TRACK ANOMALY DETECTION METHOD AND APPARATUS, COMPUTER DEVICE, AND STORAGE MEDIUM

(71) Applicant: Tencent Technology (Shenzhen) Company Limited, Shenzhen (CN)

(72) Inventor: Meng LV, Shenzhen (CN)

(73) Assignee: Tencent Technology (Shenzhen) Company Limited, Shenzhen (CN)

(21) Appl. No.: 19/058,799

(22) Filed: Feb. 20, 2025

Related U.S. Application Data
(63) Continuation of application No. PCT/CN2023/127822, filed on Oct. 30, 2023.

(30) Foreign Application Priority Data
Feb. 27, 2023 (CN) 202310208450.9

(51) Int. Cl. G01C 21/36; G08G 1/0962

(52) U.S. Cl. CPC G01C 21/3691; G08G 1/0962

(57) ABSTRACT

A track anomaly detection method, performed by a computer device includes, acquiring a location to be detected in a moving track generated by a moving object; determining a target grid to which the location to be detected belongs from grids obtained by performing, based on an actual geographic area, gridding processing; determining at least one historical grid related to the moving object, the at least one historical grid being obtained based on a historical location, located within a preset time range, in the moving track generated by the moving object; and determining, according to a location relationship between the target grid and the at least one historical grid, an anomaly detection result of the moving track, transmitting, based on the anomaly detection result indicating the location to be detected is an abnormal location point, information to a terminal, to cause the terminal to display a warning prompt to a user.

### CROSS-REFERENCE TO RELATED APPLICATIONS

This application is a continuation application of International Application No. PCT/CN2023/127822 filed on Oct. 30, 2023, which claims priority to Chinese Patent Application No. 202310208450.9 filed with the China National Intellectual Property Administration on Feb. 27, 2023, the disclosures of each being incorporated by reference herein in their entireties.

### FIELD

The disclosure relates to the technical field of information processing, and to a track anomaly detection method and apparatus, a computer device, and a storage medium.

### BACKGROUND

With the development of the technology of Internet of Vehicles, many products can provide, based on a traveling track of a vehicle, diversified service functions, for example, give a prompt about a congestion status of a road ahead. In these service functions, location information plays a very important role. However, due to reasons such as an abnormal system or abnormal collection of a hardware device, abnormal location information may be collected, which in turn greatly affects correctness of subsequent calculation.

In the related art, a location collected at a current moment is compared with a historical location, and by determining whether the collected location is abnormal, whether a track has an anomaly is further determined. When a travel time span of a vehicle is relatively long, and more and more location data is generated, a calculation amount increases dramatically, and high resource overheads may be consumed.

### SUMMARY

According to an aspect of the disclosure, a track anomaly detection method, performed by a computer device includes, acquiring a location to be detected in a moving track generated by a moving object; determining a target grid to which the location to be detected belongs from a plurality of grids obtained by performing, based on an actual geographic area, gridding processing; determining at least one historical grid related to the moving object, the at least one historical grid being obtained based on a historical location, located within a preset time range, in the moving track generated by the moving object; and determining, according to a location relationship between the target grid and the at least one historical grid, an anomaly detection result of the moving track, transmitting, based on the anomaly detection result indicating the location to be detected is an abnormal location point, information to a terminal, to cause the terminal to display a warning prompt to a user.

According to an aspect of the disclosure, a track anomaly detection apparatus includes, at least one memory configured to store computer program code; and at least one processor configured to read the program code and operate as instructed by the program code, the program code including acquiring code configured to cause at least one of the at least one processor to determine a location to be detected in a moving track generated by a moving object; first determining code configured to cause at least one of the at least one processor to determine a target grid to which the location to be detected belongs from a plurality of grids obtained by performing, based on an actual geographic area, gridding processing; second determining code configured to cause at least one of the at least one processor to determine at least one historical grid related to the moving object, the at least one historical grid being obtained based on a historical location, located within a preset time range, in the moving track generated by the moving object; detecting code configured to cause at least one of the at least one processor to determine, according to a location relationship between the target grid and the at least one historical grid, an anomaly detection result of the moving track; and transmitting code configured to cause at least one of the at least one processor to transmit, based on the anomaly detection result indicating the location to be detected is an abnormal location point, information to a terminal, to cause the terminal to display a warning prompt to a user.

According to an aspect of the disclosure, a non-transitory computer-readable storage medium, storing computer code which, when executed by at least one processor, causes the at least one processor to at least determine a location to be detected in a moving track generated by a moving object; determine a target grid to which the location to be detected belongs from a plurality of grids obtained by performing, based on an actual geographic area, gridding processing; determine at least one historical grid related to the moving object, the at least one historical grid being obtained based on a historical location, located within a preset time range, in the moving track generated by the moving object; determine, according to a location relationship between the target grid and the at least one historical grid, an anomaly detection result of the moving track; and transmit, based on the anomaly detection result indicating the location to be detected is an abnormal location point, information to a terminal, to cause the terminal to display a warning prompt to a user.

### BRIEF DESCRIPTION OF THE DRAWINGS

To describe the technical solutions in some embodiments or the technology more clearly, the following briefly describes the accompanying drawings for describing some embodiments or the technology. Apparently, the accompanying drawings in the following descriptions show merely some embodiments, and a person of ordinary skill in the art may still derive other drawings from these accompanying drawings without creative efforts.

FIG. 1 is a diagram of an application environment of a track anomaly detection method in some embodiments.

FIG. 2 is a diagram of an application environment of a track anomaly detection method in some embodiments.

FIG. 3 is a schematic flowchart of the track anomaly detection method in some embodiments.

FIG. 4 is a schematic diagram of various grids in some embodiments.

FIG. 5A is a schematic diagram of a historical grid related to a moving object in some embodiments.

FIG. 5B is a schematic diagram of a historical grid related to a moving object in some embodiments.

FIG. 6 is a schematic diagram of a location relationship among grids in some embodiments.

FIG. 7 is a schematic diagram of grids in different grid sizes in some embodiments.

FIG. 8A is a schematic principle diagram of a theoretical grid distance in some embodiments.

FIG. 8B is a schematic principle diagram of a theoretical grid distance in some embodiments.

FIG. 9 is a schematic diagram of a track of the moving object in some embodiments.

FIG. 10 is a schematic diagram of a track of the moving object in a scenario of crossing a tunnel in some embodiments.

FIG. 11 is a schematic diagram of an interface displayed by an anomaly detection result in some embodiments.

FIG. 12 is a schematic flowchart of a server updating a data set in some embodiments.

FIG. 13 is a structural block diagram of a track anomaly detection apparatus in some embodiments.

FIG. 14 is a diagram of an internal structure of a computer device in some embodiments.

### DESCRIPTION OF EMBODIMENTS

The technical solutions in some embodiments are clearly and completely described in the following with reference to the accompanying drawings in some embodiments. Apparently, the described embodiments are merely some rather than all of some embodiments. All some embodiments obtained by a person of ordinary skill in the art based on some embodiments without creative efforts shall fall within the protection scope of this application.

In the related art, whether a track has an anomaly is determined by calculating a distance between locations. For example, when N locations exist in a section of track, a distance between every two locations is calculated to determine whether the track has an anomaly, and a calculation amount may reach the order of magnitude of N². For example, if a client on a vehicle acquires a location of the vehicle at a sampling frequency of one second and transmits the same to a server, there will be 1800 pieces of location data within 30 minutes. If a distance between every two locations in the location data may be calculated, two locations freely permuted and combined among 1800 locations may be calculated respectively, and calculation may be performed 153 w times. This is merely a calculation amount for one vehicle. In a current scenario of Internet of Vehicles, a number of vehicles transmitting data at the same time may reach up to the level of millions. A number of times of calculation may reach 1500 billion, which is significantly an extremely massive calculation task. The location data usually further carries data for other service functions, such as a time stamp and a fuel level, which will consume a huge amount of storage resource.

In view of this, some embodiments provide a track anomaly detection method, in which an association relationship between locations is determined according to a location relationship between grids, thereby greatly reducing a calculation amount and significantly reducing consumption of a calculation resource and the storage resource.

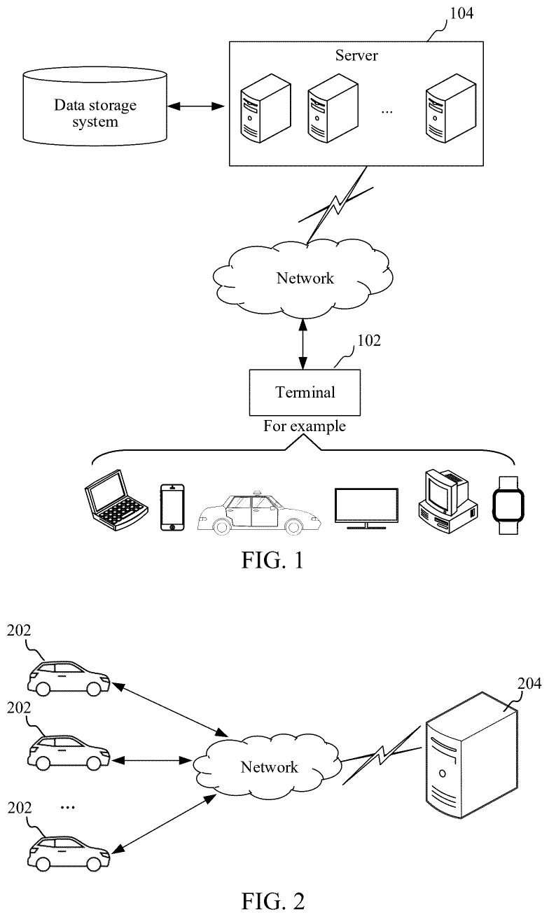

The track anomaly detection method provided in some embodiments of this application may be applied to an application environment shown in FIG. 1. A terminal 102 is connected to a server 104 for communication. The terminal 102 and the server 104 may be directly or indirectly connected in wired or wireless communication, which is not limited in some embodiments. A data storage system may store data that may be processed by the server 104. The data storage system may be integrated on the server 104, or may be placed on a cloud or another server.

The track anomaly detection method provided in some embodiments of this application may be independently performed or cooperatively performed by the terminal 102 or the server 104. In some embodiments, the terminal 102 or the server 104 acquires a location to be detected in a moving track generated by a moving object. For example, the terminal 102 acquires the location to be detected in the moving track generated by the moving object for calculation, or the server 104 acquires the location to be detected uploaded by the terminal 102. The terminal 102 or the server 104 determines a target grid to which the location to be detected belongs from a plurality of grids obtained by performing, based on an actual geographic area, gridding processing; determines at least one historical grid related to the moving object, the at least one historical grid being obtained based on a historical location, located within a preset time range, in the moving track generated by the moving object; and determines, according to a location relationship between the target grid and the at least one historical grid, an anomaly detection result of the moving track. After determining the anomaly detection result of the moving track, the server 104 may send the anomaly detection result to the terminal 102. After determining the anomaly detection result of the moving track, the terminal 102 may report the anomaly detection result to the server 104.

The terminal 102 may be a smartphone, a tablet computer, a notebook computer, a desktop computer, a smart speaker, a smartwatch, an in-vehicle terminal, a smart television, or the like, but is not limited thereto. The server 104 may be an independent physical server, or may be a server cluster or a distributed system comprised of a plurality of physical servers or a cloud server providing cloud computing, cloud storage, and other cloud computing services such as big data. The terminal 102 and the server 104 may be directly or indirectly connected in wired or wireless communication, which is not limited in some embodiments.

The track anomaly detection method provided in some embodiments of this application may also be applied to an application environment shown in FIG. 2. A terminal 202 is an in-vehicle terminal, and is deployed on a manned vehicle or an unmanned vehicle. Multiple terminals 202 are respectively connected to a cloud server 204 for communication. In some embodiments, a persistent connection is established between the terminal 202 and the cloud server 204, and then data interaction is performed based on the persistent connection, which can avoid resource consumption caused by frequent connection establishment. The cloud server 204 may process, in a manner such as parallel computing or distributed computing, data transmitted by the multiple terminals 202 to detect an anomaly of a track.

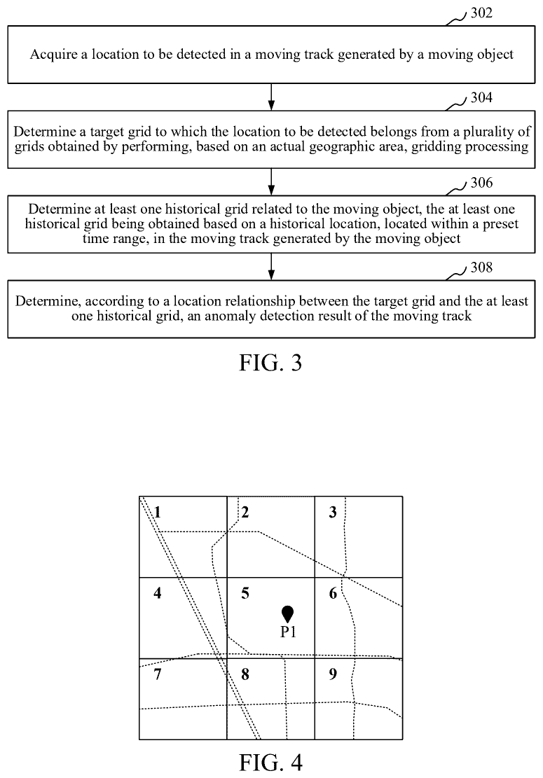

In some embodiments, as shown in FIG. 3, a track anomaly detection method is provided. The method may be applied to a terminal or a server, or may be cooperatively performed by the terminal and the server. The method is described below by using an example in which the method is applied to the server. The method includes the following operations.

Operation 302: Acquire a location to be detected in a moving track generated by a moving object.

The moving object is an object that moves. The moving object may be a living creature or an unliving creature. The moving object includes, but is not limited to, a manned vehicle, an unmanned vehicle, an unmanned aerial vehicle, a pedestrian, an animal, or the like. The location to be detected is a location, in the moving track, that may be detected for anomaly. The moving track generated by the moving object is a moving track formed by recording locations passed by the moving object in a moving process.

The moving track is a set of various locations of the moving object in a period of time. The location of the moving object is configured for representing a location of the moving object in the real physical world, and may be usually represented in a form of longitude and latitude. A location sequence formed by arranging the various locations of the moving object according to time can record a route in which the moving object moves during the period of time.

In some embodiments, a device (or terminal) loaded on the moving object may collect the location of the moving object by using a global positioning system (GPS) or a BeiDou satellite navigation system, and report the collected location to the server. In some embodiments, a terminal loaded on the moving object runs location based services (LBS), and acquires the location of the moving object by using various types of positioning technologies.

Specifically, that the server acquires the location to be detected in the moving track generated by the moving object includes: receive a data package passed back by the device loaded on the moving object; and parse the data package, and extract location data carried in the data package so that the location to be detected can be obtained. The data package further carries other relevant data of the moving object, such as one or more of an altitude, a remaining fuel level, a remaining battery power, or time.

In some embodiments, the server may perform anomaly detection on the track of the moving object in real time. In a process of the terminal reporting the location to the server in real time, the server uses a location acquired at a current moment as the location to be detected, and performs subsequent anomaly detection.

In some embodiments, the server may perform lagging anomaly detection on the track of the moving object. After the terminal reports locations in a period of time to the server, the server sequentially uses the acquired locations as the location to be detected, and performs subsequent anomaly detection respectively.

Operation 304: Determine a target grid to which the location to be detected belongs from a plurality of grids obtained by performing, based on an actual geographic area, gridding processing.

The server performs, based on the actual geographic area, gridding processing in advance, to obtain the plurality of grids corresponding to the actual geographic area. All the locations of the moving object can be respectively hashed into the different grids. Based on the Pigeonhole principle, different locations distributed in the same grid have the same characteristic. The characteristic is, for example, that speeds are the same, or a speed difference is within a threshold. The grids may be understood as small boxes divided from one actual geographic area.

In some embodiments, that the server performs, based on the actual geographic area, gridding processing includes: perform location based hashing processing on the actual geographic area, thereby dividing the actual geographic area to obtain a plurality of grids. A shape of the grid may be rectangular, but may also be a regular geometric shape such as a pentagon or a hexagon. To simplify the calculation amount, the grid may be set to be square. The location based hashing processing is location based hash processing, and may be implemented by using a location hash algorithm. The location hash algorithm includes, but is not limited to, one or more of a GeoHash algorithm, a rounding algorithm, or the like. In the GeoHash algorithm, two-dimensional longitude and latitude data is converted into a one-dimensional character string, and one character string represents one rectangular area, so that the actual geographic area is divided into a plurality of rectangular areas, and each rectangular area is a grid. In the rounding algorithm, a rounding operation is performed on longitude and latitude data, and index information is determined according to a rounded value, so that a plurality of grids of a fixed grid size can be obtained and each grid has respective index information.

In some embodiments, that determine a target grid to which the location to be detected belongs from a plurality of grids obtained by performing, based on an actual geographic area, gridding processing includes: perform, based on the actual geographic area, gridding processing to obtain the plurality of grids, each grid corresponding to an area in the actual geographic area; and determine, according to an acquired area corresponding to the grid into which the location to be detected falls, the grid into which the location to be detected falls as the target grid to which the location to be detected belongs.

For example, in all grids 1 to 9 shown in FIG. 4, the server determines, according to a grid 5 into which a location to be detected P1 falls, the grid 5 as the target grid to which the location to be detected belongs.

In some embodiments, the server performs location based hashing processing on the location to be detected by using the same location hash algorithm in a process of performing, based on the actual geographic area, gridding processing, to determine, according to a character string, index information, or the like corresponding to the location to be detected, the target grid to which the location to be detected belongs.

Operation 306: Determine at least one historical grid related to the moving object, the at least one historical grid is obtained based on a historical location, located within a preset time range, in the moving track generated by the moving object.

The preset time range is configured for specifying a location within which period of time is to be subjected to anomaly detection. In the lagging track anomaly detection, the server may perform anomaly detection on tracks of a plurality of moving objects respectively each day, and then the preset time range is one day. In real-time track anomaly detection, the server may shorten the preset time range to, for example, 10 minutes, 30 minutes, or 60 minutes.

In some embodiments, the server may obtain, based on big data analysis, an average time consumption of each segment of moving track of multiple moving objects in the same actual geographic area, and adaptively set the preset time range according to the average time consumption.

For example, the server sets a sliding window in stream computing, and a time period corresponding to the sliding window is the preset time range. Each track anomaly detection is for a location acquired within the preset time range corresponding to the sliding window.

The historical location is a location that is located within the preset time range and that is acquired before the location to be detected. The historical grid is a grid to which the historical location belongs.

Because possible packet loss, delays, or the like in network transmission, actual acquisition time of the historical location acquired by the server is not necessarily prior to actual acquisition time of the location to be detected.

For example, the terminal transmits a data packet Package1 to the server at time t to report that the moving object is located at a location A, and transmits a data packet Package2 to the server at time t+1 to report that the moving object is located at a location B. Due to network fluctuation, the server first receives the data packet Package2, parses the data packet Package2 to obtain the location B, and performs anomaly detection on the location B. After the server receives the data packet Package1 and parses the data packet to acquire the location A, the location B is a historical location of the location A.

In some embodiments, that the server determines at least one historical grid related to the moving object includes: determine all historical locations located within the preset time range; determine historical grids to which all the historical locations respectively belong; and use the historical grids respectively corresponding to all the historical locations as the historical grids related to the moving object.

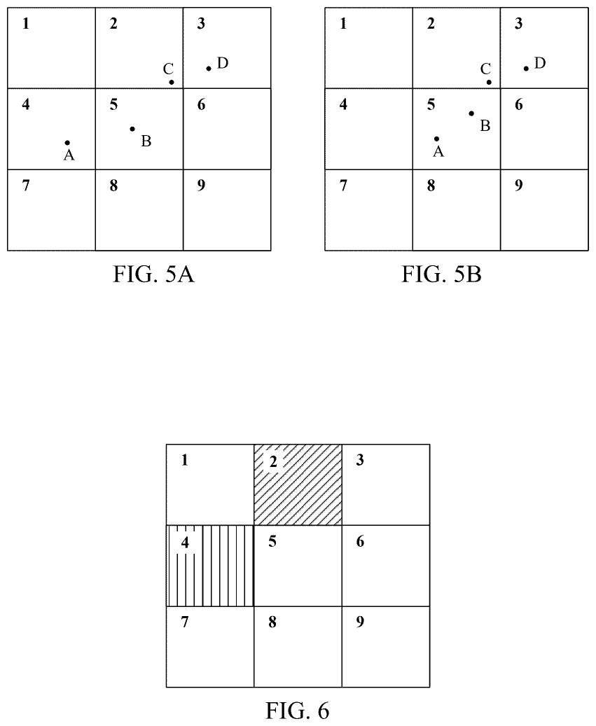

For example, as shown in FIG. 5A, the server acquires all historical locations before a location to be detected D, including the location A, the location B, and a location C. The server uses a historical grid (corresponding to a grid 4) to which the location A belongs, a historical grid (corresponding to a grid 5) to which the location B belongs, and a historical grid (corresponding to a grid 2) to which the location C belongs all as the historical grids related to the moving object.

In some embodiments, that the server determines at least one historical grid related to the moving object includes: determine all historical locations located within the preset time range; perform deduplication processing on a plurality of historical locations belonging to the same historical grid respectively to obtain a plurality of target historical locations, where historical grid corresponding to each target historical location have no duplication; and use the historical grids corresponding to each target historical location as the historical grid related to the moving object.

That the server performs deduplication processing on a plurality of historical locations belonging to the same historical grid to determine a target historical location includes: select a historical location of the plurality of historical locations belonging to the same historical grid as the target historical location. The server may randomly select any historical location as the target historical location, or the server may also select a historical location later in acquisition time.

For example, as shown in FIG. 5B, the server acquires historical locations that are before the location to be detected D and respectively belong to different historical grids, including the location A, the location B, and the location C. Because the location A and the location B belong to the same historical grid (corresponding to the grid 5), the server determines that the target historical locations are the location C and one of the location A or the location B. The server determines historical grids respectively corresponding to the target historical locations as the historical grids related to the moving object, for example, the historical grids related to the moving object are the grid 5 and the grid 2.

To ensure that data keeps updating in a real-time detection process, thereby improving detection accuracy, in some embodiments, the server stores only latest location data in one grid. After the server acquires the location to be detected and determines the target grid to which the location to be detected belongs, if the server further stores a previously determined historical location also belonging to the target grid, the server replaces the historical location with the location to be detected, to update the stored location data. Each grid only may store one piece of location data correspondingly, which can greatly reduce consumption of the storage resource.

Operation 308: Determine, according to a location relationship between the target grid and the at least one historical grid, an anomaly detection result of the moving track.

The server determines, according to the location relationship between the target grid and the at least one determined historical grid, an association relationship between the location to be detected and the historical location by using an association relationship between the grids, to determine whether the location to be detected is abnormal.

Because various locations in a normal moving track are reasonably distributed in space and time, based on the idea of the Pigeonhole Principle and with reference to an actual physical condition, when the target grid and the historical grid have an association relationship, an association relationship also exists between the location to be detected belonging to the target grid and the historical location belonging to the historical grid. In a case that the association relationship exists, it can be determined that the location is appropriate.

The server further determines, according to a determining result about whether each location in the moving track is abnormal, whether the moving track to which the location to be detected of the moving object belongs has an anomaly to finally obtain the anomaly detection result of the moving track. The anomaly detection result of the moving track includes a result that there is no anomaly and a result that there is an anomaly.

The location relationship between the target grid and the at least one historical grid includes any one of an equivalent location relationship, an adjacent location relationship, and an independent location relationship.

The equivalent location relationship represents that the target grid is any one of the at least one historical grid. When the location relationship between the target grid and the historical grid is the equivalent location relationship, the target grid and the historical grid are essentially the same grid.

The adjacent location relationship represents that the target grid is adjacent to any one of the at least one historical grid. That the target grid is adjacent to the historical grid means that the target grid is any grid in 8 surrounding grids that are connected to the historical grid by using the historical grid as a center. As shown in FIG. 6, grids 1 to 4 and grids 5 to 9 are all grids adjacent to the grid 5.

The independent location relationship represents that the target grid is not any one of the at least one historical grid and the target grid is not adjacent to each of the at least one historical grid.

Still as shown in FIG. 6, in a case that the server determines that the target grid is the grid 2, if the historical grid to which the historical location belongs is also the grid 2, the target grid and the historical grid have the equivalent location relationship. If the historical grid to which the historical location belongs is the grid 4, the target grid and the historical grid are in the adjacent location relationship. If the historical grid to which the historical location belongs is the grid 9, the target grid is neither equivalent to the historical grid nor adjacent to the historical grid, the target grid and the historical grid are in the independent location relationship.

In a case that all locations in the moving track are appropriate, the moving track is normal, for example, the anomaly detection result is that there is no anomaly. In a case that any location in the moving track has an anomaly, the moving track is abnormal, the anomaly detection result is that there is an anomaly.

In the above track anomaly detection method, the location to be detected in the moving track generated by the moving object is acquired, and the target grid to which the location to be detected belongs is determined from the plurality of grids obtained by performing, based on the actual geographic area, gridding processing. At least one historical grid obtained based on the historical location, located in the preset time range, in the moving track generated by the moving object is determined, the location relationship between the target grid and the at least one historical grid is determined, and the anomaly detection result of the moving track is determined according to the location relationship between the grids. Every two locations may not be calculated one by one, thereby greatly reducing the calculation amount and time complexity, reducing consumption of the calculation resource, and improving detection efficiency of an abnormal track. In an Internet of vehicle scenario, a number of vehicles connected to a network at the same time may reach the order of magnitude of millions. Therefore, saving the calculation resource and the storage resource becomes more prominent, and efficiency of detecting the abnormal track is improved more significantly.

In an actual scenario, due to problems such as a poor network signal that may occur in a signal transmission process, cases that a location in the moving track drifts, or a part of a road section is missing (for example, the moving object traverses a tunnel) or the like may occur. In the related art, because whether a location is abnormal may be determined in a manner of location absorption or location pairwise calculation, the part of locations may be incorrectly determined as abnormal, leading to abnormal track detection. In addition, the terminal passes location data collected in real time back to the server in real time. A problem such as packet loss and delay may occur in a network transmission process, and after asynchronous processing, calculation, and storage performed by the server, some location data is no longer arranged according to an original sequence during anomaly detection. This not only causes an extra calculation amount, but also causes an abnormal track detection. In the track anomaly detection method provided in some embodiments of this application, a location that drifts or spans is determined according to the location relationship between a grid and a historical grid thereof. When an association relationship exists between grids, given a fixed grid size, an association relationship also exists between locations of grids that have the association relationship, and the location can be well identified as a normal location. Therefore, by using a spatial distribution rule of the track and in combination with the actual physical condition, a location point that violates an objective physical rule can be accurately analyzed and warned, thereby greatly improving the accuracy of track anomaly detection.

In some embodiments, before determining the target grid to which the location to be detected belongs from the plurality of grids obtained by performing, based on the actual geographic area, gridding processing, the method further includes: determine, based on a road feature in the actual geographic area, at least one grid size; and perform, according to the at least one grid size, gridding processing on the actual geographic area to obtain the plurality of grids.

The road feature includes, but is not limited to, one or more of a road congestion status, a road pavement width, a road density, or a road traffic volume. The road feature may be configured for reflecting a traveling speed on a road. A grid size corresponding to each area may be respectively determined according to road features of different areas in the actual geographic area, to obtain one or more grid sizes corresponding to the actual geographic area.

For example, a larger grid size may be set in a high-speed area, and a smaller grid size may be set in a low-speed area (such as a city center area or a ramp area). The higher the traveling speed in the area, the larger the corresponding grid size; the lower the traveling speed in the area, the smaller the corresponding grid size. A larger grid size may be set in an area with few roads, and a smaller grid size may be set in an area with dense roads. The greater the road density in the area, the smaller the corresponding grid size; the smaller the road density in the area, the larger the corresponding grid size.

In some embodiments, that determine, based on a road feature in the actual geographic area, at least one grid size includes: determine, based on the road feature of each area in the actual geographic area, a grid size corresponding to each area respectively. That the server performs gridding processing on the actual geographic area according to the at least one grid size to obtain the plurality of grids includes: perform gridding processing on the actual geographic area according to the grid size corresponding to each area to obtain the plurality of grids.

In some embodiments, the server determines a grid size for the actual geographic area, and performs gridding processing on the actual geographic area according to the grid size to obtain the plurality of grids.

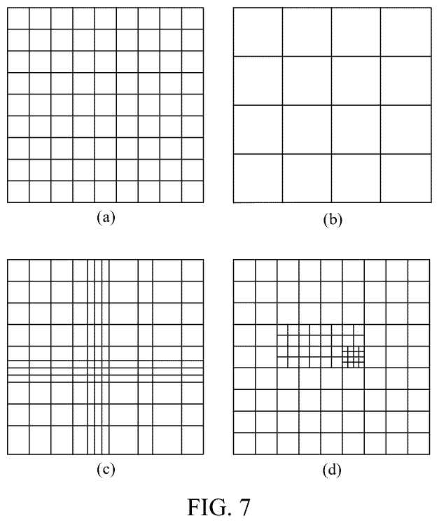

As shown in FIG. 7(a), the server determines a grid size for the actual geographic area, and performs gridding processing on the actual geographic area according to the grid size to obtain the plurality of grids of the same size.

In a case that one grid size is set, as shown in FIG. 7(b), the server may also adaptively increase the grid size (or decrease the grid size) according to the road feature of the actual geographic area.

As shown in FIG. 7(c), the server determines, based on the road feature of each area in the actual geographic area, a grid size corresponding to each area respectively, and then performs gridding processing on the actual geographic area according to the grid size corresponding to each area, to obtain the plurality of grids. All the grids may be the same or different in size, presenting a state of being dense in some parts and sparse in others.

When the grid size is set to be square, as shown in FIG. 7(d), the server may further divide the grid according to the road feature. The grids are squares with different sizes.

In the above embodiment, the grid size is adaptively adjusted according to the road feature of the actual geographic area, so that with reference to the spatial distribution rule of the track and the actual physical condition, the anomaly detection result is more accurate.

In some embodiments, that determine, based on a road feature in the actual geographic area, at least one grid size includes: divide, based on the road feature in the actual geographic area, the actual geographic area, to obtain at least one feature area; determine, for each feature area, a theoretical grid distance between any two locations when location sampling is performed at a preset sampling interval; and determine, according to the theoretical grid distance of each feature area, a grid size corresponding to each feature area, the grid size corresponding to each feature area constituting at least one grid size corresponding to the actual geographic area.

The server divides, based on the road feature in the actual geographic area, the actual geographic area to obtain the at least one feature area, where different feature areas correspond to different grid sizes. Because a frequency of sampling the location of the moving object is preset, the server determines, according to the preset sampling interval, the theoretical grid distance between any two locations when location sampling is performed at the preset sampling interval. The theoretical grid distance refers to a maximum plane distance between any two locations within the same grid.

That the server determines, for each feature area, the theoretical grid distance between any two locations when location sampling is performed at the preset sampling interval includes: the server calculates, based on a preset theoretical moving speed corresponding to each feature area, the theoretical grid distance between any two locations when location sampling is performed at the preset sampling interval in a case that the moving object moves according to the theoretical moving speed.

For example, the preset sampling interval is t, and the preset theoretical moving speed is Speedₘₐₓ (in kilometer/hour), and then a relationship between the theoretical moving speed and the theoretical grid distance D (in m) may be expressed by the following formula:

$${Speed}_{max} = \frac{D * 3600}{1000 * t}$$

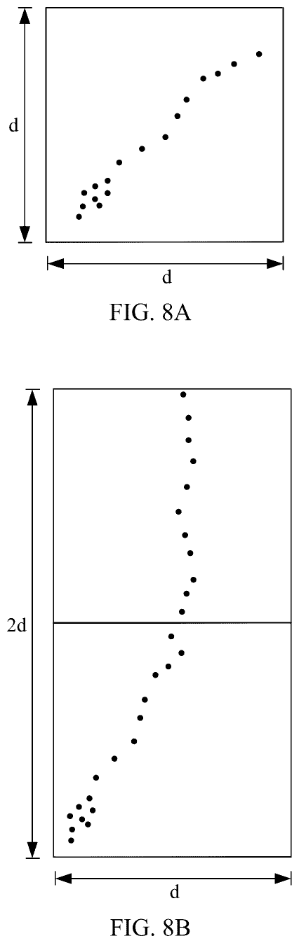

As shown in FIG. 8A, using square grids as an example, a theoretical grid distance D is a length of a diagonal line. Assuming that a grid has a side length d, a maximum plane distance between any two locations belonging to the same grid is √2d, for example, D=√2d.

After the theoretical grid distance is determined, the server may determine, according to the theoretical grid distance of each feature area, a grid size corresponding to each feature area. For example, the server may use the theoretical grid distance as the side length of the square grid. For another example, the server may use a multiple of the theoretical grid distance as the side length of the grid. When the grid is not square, the server may actually adjust, based on the theoretical grid distance, the grid size. The grid size corresponding to each feature area constitutes at least one grid size corresponding to the actual geographic area.

In some embodiments, by adaptively adjusting the grid size according to the road feature of the actual geographic area with reference to the actual physical condition, different grid sizes can be divided for the actual geographic area in a targeted manner with reference to the spatial distribution rule of the track, so that when anomaly detection is performed on the location in the grid subsequently, the anomaly detection result is more accurate.

In some embodiments, that determine, for each feature area, a theoretical grid distance between any two locations when location sampling is performed at a preset sampling interval includes: determine, for each feature area, a theoretical moving speed corresponding to the feature area; and determine a theoretical grid distance between any two locations obtained through sampling when location sampling is performed at the preset sampling interval in a case that the moving object moves according to the theoretical moving speed.

The server determines, for each feature area, the theoretical moving speed corresponding to the feature area. The theoretical moving speed refers to a maximum moving speed of the moving object. The theoretical moving speed may be manually set according to experience. For example, a theoretical moving speed of a vehicle in an urban area does not exceed 120 km/h. The grid size is determined by the theoretical moving speed.

In a scenario in which anomaly detection is performed on a moving object in a city, to accurately detect whether tracks of different moving objects belonging to the same city are abnormal, the preset theoretical moving speed may be reduced, and a fine granularity is increased, so that an abnormal result can be detected more sensitively.

In inter-city and inter-province scenarios, tracks of different moving objects that do not belong to the same province do not have an intersection set. The preset theoretical moving speed can be increased, and the fine granularity can be reduced, so that whether a location has a jump anomaly with a large span can be more significantly determined. The theoretical moving speed may be set according to a purpose of track anomaly detection and an application scenario. For example, to detect whether a location has a jump anomaly with a large span, the theoretical moving speed may be set to 500 KM/h to reduce many unnecessary misjudgments.

After the server determines the theoretical moving speed corresponding to the feature area, the theoretical grid distance between any two locations obtained through sampling is assumed when the moving object moves according to the theoretical moving speed and locations of the moving object are sampled at the preset sampling interval. The grid size may be determined according to the theoretical grid distance.

In the above embodiment, by adaptively adjusting the grid size according to the road feature of the actual geographic area with reference to the actual physical condition, different grid sizes can be divided for the actual geographic area in a targeted manner with reference to the spatial distribution rule of the track, so that when anomaly detection is performed on the location in the grid subsequently, the anomaly detection result is more accurate.

In some embodiments, each grid in the plurality of grids has a respective grid code. As shown in FIG. 4, each grid corresponds to its own code, for example, a grid 1 and a grid 2. Correspondingly, that determine a target grid to which the location to be detected belongs from a plurality of grids obtained by performing, based on an actual geographic area, gridding processing includes: acquire location information of the location to be detected; perform a hash operation on the location information of the location to be detected to obtain a target grid code corresponding to the location to be detected; and determine, in the plurality of grids, a grid having the target grid code as the target grid to which the location to be detected belongs.

After acquiring the location to be detected, the server extracts the location information of the location to be detected. The location information is, for example, longitude and latitude data. The server performs the hash operation on the location information of the location to be detected to obtain the target grid code corresponding to the location to be detected, where the target grid code is configured for indicating the grid to which the location to be detected belongs. The server may find, according to the target grid code, a corresponding grid in the plurality of grids, for example, the server determines the grid having the target grid code as the target grid to which the location to be detected belongs.

In some embodiments, when the server performs the hash operation on the location information of the location to be detected, a location hash algorithm that is the same as that used when the gridding processing is performed based on the actual geographic area may be used.

In the above embodiment, by performing the hash operation on the location information of the location to be detected, the grid to which the location to be detected belongs is obtained, and then anomaly detection is performed based on an association relationship between grids. Specific longitude and latitude data of the location to be detected may not be calculated, thereby greatly reducing the calculation amount and improving the efficiency of anomaly detection.

With reference to FIG. 8A, locations belonging to the same grid conform to an objective physical rule in terms of a speed, a time difference, and a distance, then an association relationship exists between the locations, the locations are appropriate, and there is no anomaly. As shown in FIG. 8B, still using the square grids as an example, when two grids are adjacent to each other, a distance between any two location points in the grid does not exceed \sqrt{d²+(2d)²}. The theoretical grid distance D=\sqrt{d²+(2d)²}.

It is assumed that the preset sampling interval is t, the preset theoretical moving speed is Speedₘₐₓ (in kilometers/hour), and then a relationship between the theoretical moving speed and the theoretical grid distance may be expressed by the following formula:

$${Speed}_{max} = \frac{\sqrt{{d}^{2} + {( 2 d )}^{2}} * 3600}{1000 * t}$$

After a suitable grid size is set, location points located in the same grid or adjacent grids have an appropriate association relationship.

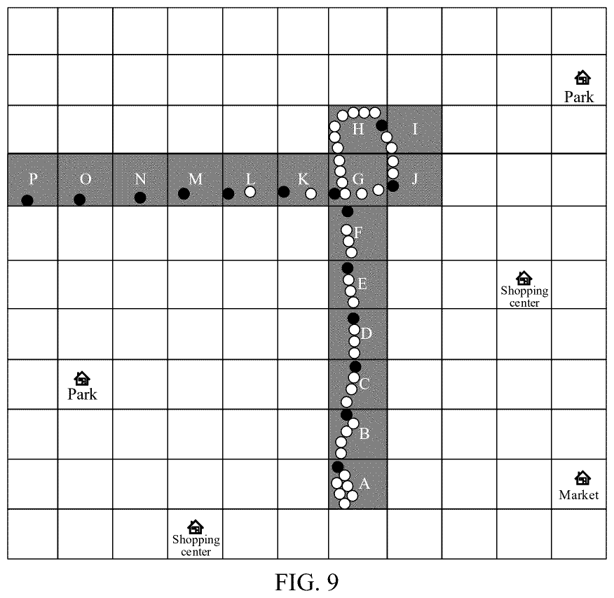

Using the track shown in FIG. 9 as an example, first piece of location data of the moving object belongs to a grid A, second piece of location data also belongs to the grid A, and the second piece of location data inevitably have an appropriate association relationship with the first piece of location data. Until a location belongs to a grid B, no location point already associated with the location exists in the grid B. However, because the grid B is adjacent to the grid A, an appropriate relationship exists between location points. By analogy, an area covered by grids [A-P] formed by the whole track is a complete and clear track sequence. In this process, only calculation for determination of a grid to which each location belongs and a few adjacency relationships may be used, and the calculation complexity may be less than a floating point calculation between every two locations.

A calculation amount of an order of magnitude of O(n²) may be used to calculate a distance and a speed relationship between every two locations to determine whether there is an anomaly. However, after the attribution is determined in a manner of a grid, a possible maximum distance and maximum speed thereof may be confirmed based on formula deduction, and a specific speed value may not be accurately calculated. The time complexity of calculation is reduced from O(n²) to O(n). It is assumed that FIG. 9 includes 64 sampling points, the time complexity of calculation may be O(n²), and calculation may be performed 2016 times. The time complexity of calculation is O(n), and calculation may be performed only 64 times, which can greatly reduce a calculation amount, and greatly reduce the consumption of the calculation resource and the storage resource.

In some embodiments, that the server determines, according to a location relationship between the target grid and the at least one historical grid, an anomaly detection result of the moving track includes: determine, according to the location relationship between the target grid and the at least one historical grid, whether an association relationship exists between the location to be detected and historical locations corresponding to the at least one historical grid; and determine, in a case that no association relationship exists, that the moving track has an anomaly.

The server determines, according to the location relationship between the target grid and the at least one historical grid, whether an association relationship exists between the location to be detected and the historical location corresponding to the at least one historical grid. In a case that the location relationship between the target grid and any historical grid is that the association relationship exists, the server may determine that the association relationship exists between the location to be detected and the historical location corresponding to the at least one historical grid. The server may determine that the current location to be detected does not have an anomaly. In a case that none of the locations of the moving track has an anomaly, the server may determine that the moving track has no anomaly.

In a case that the location relationship between the target grid and any historical grid is that no association relationship exists, the server may determine that no association relationship exists between the location to be detected and the historical location corresponding to the at least one historical grid. The server may determine that the moving track has an anomaly.

In the above embodiment, anomaly detection is performed by using the association relationship between the grids, and data of the location to be detected may not be calculated, thereby greatly reducing the calculation amount, reducing consumption of the calculation resource and the storage resource, and significantly improving the efficiency of anomaly detection.

In some embodiments, that determine, according to the location relationship between the target grid and the at least one historical grid, whether the association relationship exists between the location to be detected and the historical location corresponding to the at least one historical grid includes: determine, in a case that the location relationship between the target grid and the at least one historical grid is the equivalent location relationship, that the association relationship exists between the location to be detected and the historical location corresponding to the historical grid equivalent to the target grid.

In a case that the server determines that the location relationship between the target grid and the at least one historical grid is the equivalent location relationship, for example, in a case that the target grid is a historical grid previously recorded in this anomaly detection, the server may directly determine that the association relationship exists between the target grid and the historical grid, to directly determine that the association relationship exists between the location to be detected and the historical location corresponding to the historical grid equivalent to the target grid.

For example, the server records the grid A to which the previous location to be detected P1 belongs, and when anomaly detection is performed on a next location to be detected P2, the recorded grid A is a historical grid. In a case that the server determines that the target grid to which the location to be detected P2 belongs is also the grid A, the server directly determines that the association relationship exists between the location to be detected P2 and the location to be detected P1 in the grid A. The server determines that the location to be detected P2 does not have an anomaly.

In some embodiments, that determine, according to the location relationship between the target grid and the at least one historical grid, whether the association relationship exists between the location to be detected and the historical location corresponding to the at least one historical grid includes: determine, in a case that the location relationship between the target grid and the at least one historical grid is the adjacent location relationship, that an association relationship exists between the location to be detected and the historical location corresponding to the historical grid adjacent to the target grid.

In a case that the server determines that the location relationship between the target grid and the at least one historical grid is the adjacent location relationship, for example, in a case that the target grid is adjacent to a historical grid that is recorded previously in this anomaly detection, the server may directly determine that the association relationship exists between the target grid and the historical grid, to directly determine that the association relationship exists between the location to be detected and the historical location corresponding to the historical grid equivalent to the target grid.

For example, the server records the grid A to which the previous location to be detected P1 belongs, and when anomaly detection is performed on a next location to be detected P2, the recorded grid A is a historical grid. In a case that the server determines that the target grid to which the location to be detected P2 belongs is the grid B, because the grid A is adjacent to the grid B, the server directly determines that the association relationship exists between the location to be detected P2 and the location to be detected P1 in the grid A. The server determines that the location to be detected P2 does not have an anomaly.

In the above embodiment, anomaly detection is performed by using the association relationship between the grids, and data of the location to be detected may not be calculated, thereby greatly reducing the calculation amount, reducing consumption of the calculation resource and the storage resource, and significantly improving the efficiency of anomaly detection.

In an actual case, after the track is collected, the track may be missing due to network interruption, a positioning signal anomaly, passing through tunnels, or the like, and sometimes cannot form a complete adjacent grid relationship. For example, there is a jump situation between the location and the historical location.

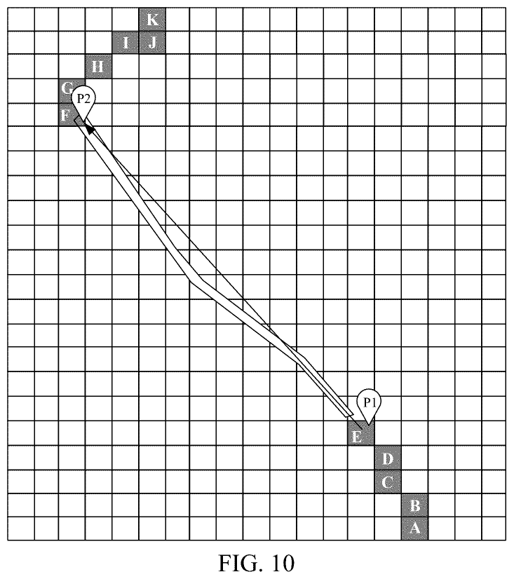

As shown in FIG. 10, a complete track is to be an area covered by grids [A-K]. The moving object drives into a tunnel at a location P1, and because a signal in the tunnel is lost, no location data can be collected. The moving object drivels out of the tunnel at a P2 location, and in this case, normal location collection and reporting are restored. In FIG. 10, sections A to E of the track may form an association relationship, and sections F to K may form an association relationship, but there is a distance of several kilometers or dozens of kilometers between E and F.

In some embodiments, that determine, according to the location relationship between the target grid and the at least one historical grid, whether the association relationship exists between the location to be detected and the historical location corresponding to the at least one historical grid includes: determine, in a case that the location relationship between the target grid and the at least one historical grid is the independent location relationship, at least one target historical location from the historical location corresponding to the at least one historical grid; determine movement feature data between the location to be detected and the at least one target historical location respectively; and for each target historical location, determine, based on the at least one piece of the movement feature data, whether the association relationship exists between the location to be detected and the target historical location.

In a case that the location relationship between the target grid and the at least one historical grid is the independent location relationship, for example, the target grid and the historical grid are neither the same grid nor adjacent to each other, further determining may be performed in this case. For example, as shown in FIG. 10, when the server acquires the location to be detected P2 and determines that a target grid to which the location to be detected P2 belongs is a grid F, the grid F is not adjacent to any of grids A to E.

The server determines at least one target historical location from the historical location corresponding to the at least one historical grid. For each historical grid, the server may select any historical location belonging to a corresponding historical grid as the target historical location corresponding to the historical grid.

The server determines movement feature data between the location to be detected and the at least one target historical location respectively. The movement feature data is, for example, an average moving speed, an actual distance, or an actual time interval (a time difference between collection time). For example, if the server acquires that acquisition time of the target historical location P1 is t1, and acquisition time of the location to be detected is t2, the actual time interval is |t2−t1|. For each target historical location, the server may determine, based on the at least one piece of movement feature data, for example, based on any one or more of the average moving speed, the actual distance, or the actual time interval, with reference to an objective physical rule, whether an association relationship exists between the location to be detected and the target historical location.

In a case that it is determined, based on the at least one piece of movement feature data, that movement of the moving object conforms to the objective physical rule, the server determines that the association relationship exists between the location to be detected and the target historical location. On the contrary, in a case that the server determines that the movement of the moving object does not conform to the objective physical rule, for example, after the moving object moves by the actual distance according to the theoretical moving speed, time it takes to reach P2 from P1 is far greater than the actual time interval. After moving for a duration of the actual time interval according to the theoretical moving speed, a moving distance may be less than the actual distance. If an average moving speed calculated based on the actual distance and the actual time interval exceeds the theoretical moving speed, the server determines that no association relationship exists between the location to be detected and the target historical location.

In the above embodiment, anomaly detection is performed by using the association relationship between the grids, and data of the location to be detected may not be calculated, thereby greatly reducing the calculation amount, reducing consumption of the calculation resource and the storage resource, and significantly improving the efficiency of anomaly detection.

In some embodiments, locations obtained by sampling the moving track generated by the moving object correspond to time information. Correspondingly, that determine movement feature data between the location to be detected and the at least one target historical location respectively includes: determine the actual distances between the location to be detected and the at least one target historical location respectively; alternatively, determine, according to the time information respectively corresponding to the location to be detected and the at least one target historical location, the actual time interval between the location to be detected and the at least one target historical location respectively.

After acquiring the location to be detected, the server can calculate, according to the location information (for example, longitude and latitude data) of the location to be detected, the actual distance to the at least one target historical location. When the terminal transmits a data packet to the server, the data packet further carries the time information. The server may calculate, according to the acquisition time corresponding to the location to be detected, the actual time interval between the location to be detected and the at least one target historical location.

Further, that for each target historical location, determine, based on the at least one piece of movement feature data, whether the association relationship exists between the location to be detected and the target historical location includes: for each target historical location, determine, based on one or more of the actual distance or the actual time interval between the location to be detected and the at least one target historical location, whether the association relationship exists between the location to be detected and the target historical location.

In some embodiments, the server determines, with reference to the actual distance and the theoretical moving speed, a difference between the calculated duration and the actual time interval. In a case that the difference does not conform to the objective physical rule, the server determines that no association relationship exists between the location to be detected and the at least one target historical location.

In some embodiments, the server determines, with reference to the actual time interval and the theoretical moving speed, a difference between the calculated distance and the actual distance. In a case that the difference does not conform to the objective physical rule, the server determines that no association relationship exists between the location to be detected and the at least one target historical location.

In some embodiments, the server determines, with reference to the actual distance and the actual time interval, a difference between the calculated average moving speed and the theoretical moving speed. In a case that the difference does not conform to the objective physical rule, the server determines that no association relationship exists between the location to be detected and the at least one target historical location.

In the above embodiment, with reference to the objective physical rule, movement features such as a corresponding distance, duration, or speed are calculated by using the movement feature data, and then an association relationship between locations in two grids that belong to the independent location relationship is determined, thereby greatly reducing the calculation amount, reducing consumption of the calculation resource and the storage resource, and significantly improving the efficiency of anomaly detection. When locations of two moving objects located at different locations are identified as a track of the same moving object (for example, when two moving objects upload data through terminals, the terminals have the same ID), location points on the track jump between actual locations of the two different moving objects. Under such a track distribution, it is bound to be impossible to meet calculation of the association relationship mentioned above, which exceeds a suitable speed of cognition, and the server can accurately detect an anomaly of a location in the track.

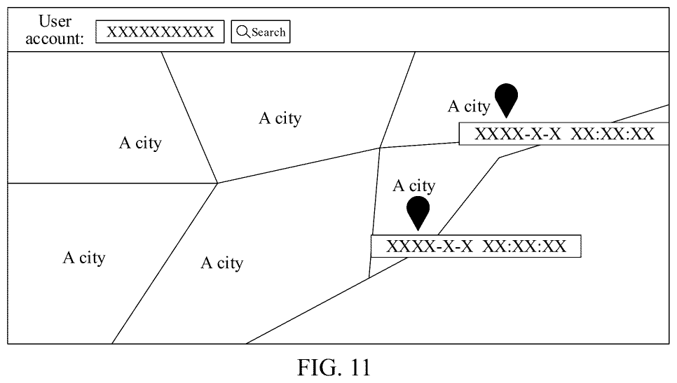

In some embodiments, the above method further includes: give out, by the server in a case that the anomaly detection result of the moving track represents that the location to be detected is an abnormal location point, a warning prompt to a user account bound with the moving object. For example, a user binds the moving object with the user account in advance by using a device loaded on the moving object, to view the historical track or the track anomaly result. When the server determines that the track anomaly detection result of the moving object represents that the location to be detected is an abnormal location point, the server gives out the warning prompt to the user account to prompt the user to check an anomaly in time. For example, the user may query the anomaly detection result by using the user account, and an interface as shown in FIG. 11 is displayed. In FIG. 11, the location data is displayed as jumping between two cities within a time interval. Therefore, by sending the warning prompt to the user account in time, a risk prompt can be made to the user in time so that user experience is high.

In an actual scenario, there may be a case that locations of two moving objects located at different locations are identified as a track of the same moving object. With the moving object being a vehicle as an example, the location based service may be provided by a software service provider. When the user registers and binds the user account, the user account may be bound with a terminal device of the vehicle. In this process, a device code of the terminal device of the vehicle may be acquired. When providing the software service provider with the device code of a vehicle terminal, a vehicle manufacturer may use measures such as encryption to avoid leakage of a real device code. Consequently, device codes of different vehicles acquired by the software service provider may be the same, leading to conflicts in the user accounts, and subsequently, tracks may repeatedly jump at different locations when users in different areas drive vehicles. The problem can be well resolved by using the track anomaly detection method provided in some embodiments of this application.

In some embodiments, the above method further includes: in a case that the anomaly detection result of the moving track represents that the location to be detected is an abnormal location point, and an actual distance of the location to be detected relative to the moving track exceeds a preset threshold, it is determined that the user account bound with the moving object has an account anomaly risk, where the account anomaly risk is configured for prompting a device manufacturer of a device loaded on the moving object to perform device detection.

The server determines, in a case that the anomaly detection result of the moving track represents that the location to be detected is the abnormal location point, whether the location point to be detected is caused by a data error (for example, a collecting device failure) or a large span jump in position.

In a case that the server determines that the actual distance of the location to be detected relative to the moving track exceeds the preset threshold, it may determine that there is a large span jump between the location to be detected and other locations. The above risk of the user account conflict, an account anomaly risk, may be likely to occur.

In the above embodiment, in a case that it is determined that the user account has the account anomaly risk, a prompt may be sent to the device manufacturer of the device loaded on the moving object to prompt the device manufacturer of the device loaded on the moving object to perform device detection, to cooperate with the device manufacturer to perform remedial measures such as upgrade, thereby avoiding a subsequent serious functional anomaly.

The above warning prompt manner is merely an example, and may be properly adjusted according to an actual case in an application scenario. Those skilled in the art shall appreciate that appropriate deformation and proper adjustment made to the above warning prompt manner fall within the protection scope of this application.

Some embodiments further provide an application scenario. The above track anomaly detection method is applied to the application scenario. Application examples of the track anomaly detection method in the application scenario is as follows: acquire a location to be detected in a moving track of a vehicle; determine a target grid to which the location to be detected belongs from a plurality of grids obtained by performing, based on an actual geographic area, gridding processing; determine at least one historical grid related to the vehicle, the at least one historical grid being obtained based on a historical location, located within a preset time range, in the moving track of the vehicle; and determine, according to a location relationship between the target grid and the at least one historical grid, an anomaly detection result of the moving track. Of course, this application is not limited thereto. The track anomaly detection provided in some embodiments may further be applied to other application scenarios, for example, a location based map service.

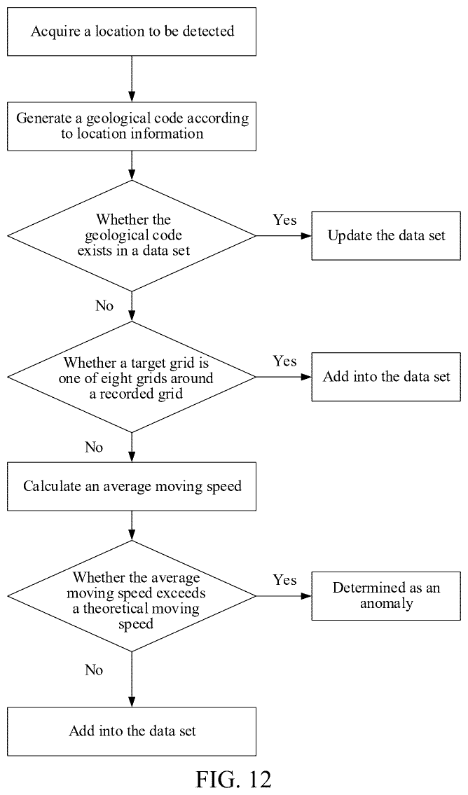

In an example, as shown in FIG. 12, when the server performs track anomaly detection, a data set is maintained at the same time. A form of the data set is dictionary mapping of <geographic code, grid location information>.

The server acquires location data in a period of time (preset time range) in a form of a sliding window in a stream computing manner. For each location to be detected in the sliding window, the server calculates a geographical code corresponding to the location to be detected by using a location hash algorithm. The geographical code has a mapping relationship with a grid code. The server may determine a target grid code to which the location to be detected belongs.

In a case that the geographical code already exists in the data set, it indicates that a target grid indicated by a current target grid code has been recorded previously, and the server updates corresponding location data in the data set, to ensure that location data in a corresponding grid in the data set is latest location data. The server may record one piece of location data for each grid, thereby greatly reducing consumption of the storage resource.

In a case that the geographical code does not exist in the data set, the server checks whether a target grid indicated by a current target grid code is one of eight grids around a historically recorded grid (for example, determines whether there is a locational association relationship with the historical grid), and if yes, the server adds the geographical code into the data set.

If none of the above conditions is met, the server performs, based on the movement feature data of the location to be detected, further calculation. Exemplarily, the server calculates an average moving speed of the location to be detected and a location in an existing data set, to determine whether the speed conforms to the objective physical law. The server compares the calculated average moving speed with a set theoretical moving speed. When the average moving speed exceeds the theoretical moving speed, the server determines that the location to be detected has an anomaly, and further determines that the anomaly detection result of the track is that there is an anomaly.

The location data is hashed by using a geographical coding technology, and the location data is hashed to different grids in a gridding manner, a track distance inside the grid is relatively short, a speed conforms to an objective rule, and there is an association relationship. Whether the grids are associated is determined by using the adjacent relationship of the grids. For location data that cannot be associated with other location data, whether separation of the location data is appropriate is determined by using any one or more of the acquired actual distance and actual time interval with reference to the theoretical moving speed, to avoid interference caused by situations such as a tunnel, and the anomaly detection result is more accurate.

When an appropriate grid size is selected, the association relationship can be determined according to the adjacent relationship between grids for most location data, which significantly reduces the calculation amount. Whether the jumping track has an anomaly may be determined by calculating whether the speed between the grids satisfies the objective physical rule, for example, an appropriate track jump and an abnormal track may be determined by means of a small amount of calculation.

In a case that a sequence of location data acquired by the server is not based on an actual collection time sequence (an out-of-sequence scenario), an anomaly is determined according to a location relationship between a currently determined grid and a previously recorded historical grid. Although a track route cannot be successively pushed through grid association in an ideal case, even if the track route is not adjacent to any historical grid, calculation may be performed only once, then the association relationship can be established. Subsequently, recursion may be made when another location point is determined, thereby being capable of reducing the calculation amount and improving an anomaly detection accuracy.

In terms of storage, location points in a single grid are similar, and location information of all locations in the same grid may not be stored. Each time a piece of new location data exists, old data in the same grid may be replaced, thereby greatly reducing consumption of the storage resource. Especially in a scenario in which there are millions of online vehicles connected to the Internet of Vehicles, an optimization effect on storage is more significant.

In some embodiments, the track anomaly detection method provided by some embodiments of this application includes: the server divides, based on the road feature in the actual geographic area, the actual geographic area to obtain at least one feature area. For each feature area, the server determines a theoretical moving speed corresponding to the feature area, and determines a theoretical grid distance between any two locations obtained through sampling when location sampling is performed at the preset sampling interval in a case that the moving object moves according to the theoretical moving speed.

The server determines, according to the theoretical grid distance of each feature area, a grid size corresponding to each feature area. The grid size corresponding to each feature area constitutes at least one grid size corresponding to the actual geographic area. Finally, the server performs, according to the at least one grid size, gridding processing on the actual geographic area to obtain a plurality of grids. Each grid has a respective grid code.

The server acquires a location to be detected in the moving track generated by the moving object, and acquires location information of the location to be detected; and performs a hash operation on the location information of the location to be detected to obtain a target grid code corresponding to the location to be detected.

In the plurality of grids, the server determines a grid having the target grid code as a target grid to which the location to be detected belongs, and determines at least one historical grid related to the moving object. The at least one historical grid is obtained based on a historical location, located within a preset time range, in the moving track generated by the moving object.

In a case that the location relationship between the target grid and the at least one historical grid is the equivalent location relationship, the server determines that an association relationship exists between the location to be detected and the historical location corresponding to the historical grid equivalent to the target grid.

In a case that the location relationship between the target grid and the at least one historical grid is the adjacent location relationship, the server determines that an association relationship exists between the location to be detected and the historical location corresponding to the historical grid adjacent to the target grid.

In a case that the location relationship between the target grid and the at least one historical grid is the independent location relationship, the server determines at least one target historical location from historical locations corresponding to the at least one historical grid, and determines movement feature data between the location to be detected and the at least one target historical location respectively. For each target historical location, the server determines, based on the at least one piece of movement feature data, whether an association relationship exists between the location to be detected and the target historical location.

The location obtained by the server by sampling the moving track generated by the moving object corresponds to time information. That determine the movement feature data between the location to be detected and the at least one target historical location respectively includes: determine the actual distances between the location to be detected and the at least one target historical location respectively; alternatively, determine, according to the time information respectively corresponding to the location to be detected and the at least one target historical location, the actual time interval between the location to be detected and the at least one target historical location respectively. That for each target historical location, the server determines, based on the at least one piece of movement feature data, whether an association relationship exists between the location to be detected and the target historical location includes: for each target historical location, determine, based on one or more of the actual distance or the actual time interval between the location to be detected and the at least one target historical location, whether the association relationship exists between the location to be detected and the target historical location.

In a case that no association relationship exists, the server determines that the moving track has an anomaly.

In the above embodiment, by analyzing a spatial distribution rule of location data in a track and using an objective and appropriate theoretical moving speed as a calculation condition, hash classification is performed on the location data in a gridding manner, thereby reducing a dimension of data participating in calculation. A volume of data to be calculated is further reduced by determining that grids are adjacent. In addition, because grid classification avoids repeated storage of similar tracks, a volume of data that may be stored in a time window can be significantly optimized. Conversely, when there is a same resource quota, by means of efficient calculation and storage performance of the algorithm, a longer time window may be set to analyze the track, and a better detection effect can be obtained.

The operations in the flowcharts involved in some embodiments are displayed in sequence based on indication of arrows, but the operations are not necessarily performed sequentially according to a sequence indicated by the arrows. Unless otherwise explicitly specified the execution sequence of the operations is not strictly limited, and the operations may be performed in other sequences. at least some operations in the flowcharts involved in some embodiments may include a plurality of operations or a plurality of stages, and these operations or stages are not necessarily performed at a same moment, and may be performed at different moments. The operations or stages are not necessarily performed in sequence, and may be performed in turns or alternately with other operations, or at least a part of operations or stages in the other operations.

Some embodiments further provide a track anomaly detection apparatus, configured to implement the above involved track anomaly detection method. An implementation solution provided by the apparatus for resolving a problem is similar to the implementation solution recorded in the above method. For specific limitations on one or more embodiments of the track anomaly detection apparatus provided below, refer to the limitations on the above track anomaly detection method.

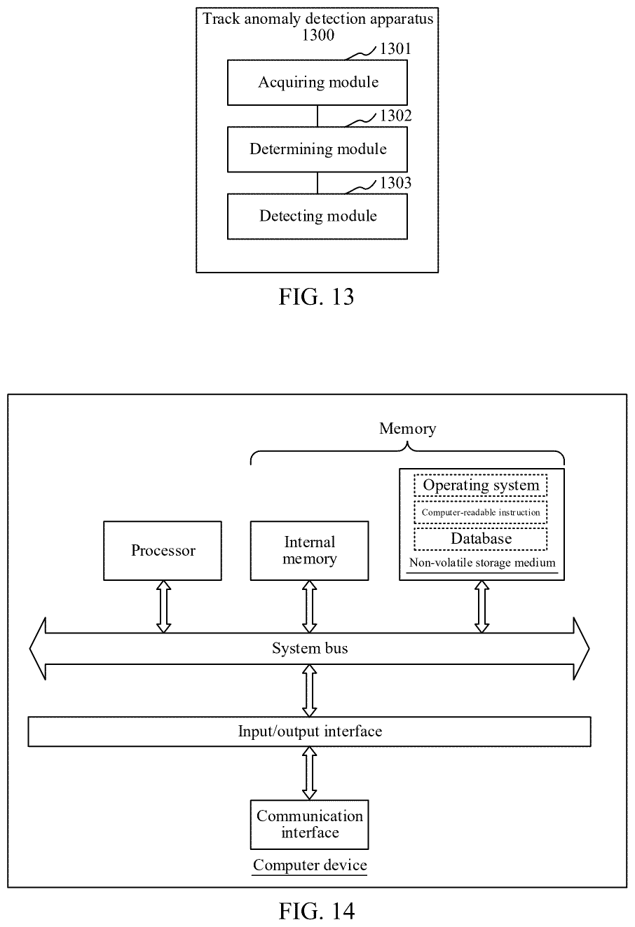

In some embodiments, as shown in FIG. 13, a track anomaly detection apparatus 1300 is provided, including: an acquiring module 1301, a determining module 1302, and a detecting module 1303.

The acquiring module 1301 is configured to determine a location to be detected in a moving track generated by a moving object.

The determining module 1302 is configured to determine a target grid to which the location to be detected belongs from a plurality of grids obtained by performing, based on an actual geographic area, gridding processing.

The determining module 1302 is further configured to determine at least one historical grid related to the moving object, the at least one historical grid being obtained based on a historical location, located within a preset time range, in the moving track generated by the moving object.

The detecting module 1303 is configured to determine, according to a location relationship between the target grid and the at least one historical grid, an anomaly detection result of the moving track.

In some embodiments, the above apparatus further includes a gridding module, configured to determine, based on a road feature in the actual geographic area, at least one grid size; and perform, according to the at least one grid size, gridding processing on the actual geographic area to obtain the plurality of grids.

In some embodiments, the gridding module is further configured to divide, based on the road feature in the actual geographic area, the actual geographic area to obtain at least one feature area; determine, for each feature area, a theoretical grid distance between any two locations when location sampling is performed at a preset sampling interval; and determine, according to the theoretical grid distance of each feature area, a grid size corresponding to each feature area, the grid size corresponding to each feature area constituting at least one grid size corresponding to the actual geographic area.

In some embodiments, the gridding module is further configured to determine, for each feature area, a theoretical moving speed corresponding to the feature area; and determine, when location sampling is performed at the preset sampling interval in a case that the moving object moves according to the theoretical moving speed, a theoretical grid distance between any two locations obtained through sampling.

In some embodiments, each grid in the plurality of grids has a respective grid code, and the determining module is further configured to acquire location information of the location to be detected; perform a hash operation on the location information of the location to be detected to obtain a target grid code corresponding to the location to be detected; and determine, in the plurality of grids, a grid having the target grid code as the target grid to which the location to be detected belongs.

In some embodiments, the detecting module is further configured to determine, according to the location relationship between the target grid and the at least one historical grid, whether an association relationship exists between the location to be detected and the historical location corresponding to the at least one historical grid; and determine, in a case that no association relationship exists, that the moving track has an anomaly.

In some embodiments, the location relationship between the target grid and the at least one historical grid includes any one of an equivalent location relationship, an adjacent location relationship, and an independent location relationship, where the equivalent location relationship represents that the target grid is any one of the at least one historical grid; the adjacent location relationship represents that the target grid is adjacent to any one of the at least one historical grid; and the independent location relationship represents that the target grid is not any one of the at least one historical grid and the target grid is not adjacent to each of the at least one historical grid.

In some embodiments, the detecting module is further configured to determine, in a case that the location relationship between the target grid and the at least one historical grid is the equivalent location relationship, that an association relationship exists between the location to be detected and the historical location corresponding to the historical grid equivalent to the target grid; and determine, in a case that the location relationship between the target grid and the at least one historical grid is the adjacent location relationship, that an association relationship exists between the location to be detected and the historical location corresponding to the historical grid adjacent to the target grid.

In some embodiments, the detecting module is further configured to determine, in a case that the location relationship between the target grid and the at least one historical grid is the independent location relationship, at least one target historical location from historical locations corresponding to the at least one historical grid; determine movement feature data between the location to be detected and the at least one target historical location respectively; and for each target historical location, determine, based on the at least one piece of movement feature data, whether an association relationship exists between the location to be detected and the target historical location.

In some embodiments, the locations obtained by sampling the moving track generated by the moving object correspond to time information. The detecting module is further configured to determine an actual distance between the location to be detected and the at least one target historical location respectively; alternatively, determine, according to the time information respectively corresponding to the location to be detected and the at least one target historical location, an actual time interval between the location to be detected and the at least one target historical location respectively. The detecting module is further configured to for each target historical location, determine, based on one or more of the actual distance or the actual time interval between the location to be detected and the at least one target historical location, whether an association relationship exists between the location to be detected and the target historical location.

In some embodiments, the above apparatus further includes a first prompting module, configured to give out, in a case that the anomaly detection result of the moving track indicates that the location to be detected is an abnormal location point, a warning prompt to a user account bound with the moving object.

In some embodiments, the above apparatus further includes a second prompting module, configured to: in a case that the anomaly detection result of the moving track indicates that the location to be detected is an abnormal location point, and the actual distance of the location to be detected relative to the moving track exceeds a preset threshold, determine that the user account bound with the moving object has an account anomaly risk, where the account anomaly risk is configured for prompting a device manufacturer of a device loaded on the moving object to perform device detection.

The first prompting module and the second prompting module may be the same prompting module, or may be different prompting modules. In some embodiments, the first prompting module and the second prompting module are the same prompting module.

All or a part of the modules in the above track anomaly detection apparatus may be implemented by means of software, hardware, or a combination thereof. The above modules may be built in or independent of a processor of a computer device in a form of hardware, or may be stored in a memory of the computer device in a form of software, for the processor to invoke and execute operations corresponding to the above modules.

In some embodiments, a computer device is provided. The computer device may be a server. A diagram of an internal structure thereof can be as shown in FIG. 14. The computer device includes a processor, a memory, an input/output (I/O for short) interface, and a communication interface. The processor, the memory, and the input/output interface are connected through a system bus, and the communication interface is connected to the system bus through the input/output interface. The processor of the computer device is configured to provide computing and control capabilities. The memory of the computer device includes a non-volatile storage medium and an internal memory. The non-volatile storage medium stores an operating system, computer programs, and databases. The internal memory provides an operating environment for the operating system and the computer programs in the non-volatile storage medium. The database of the computer device is configured to store location data. The I/O interface of the computer device is configured to exchange information between the processor and an external device. The communication interface of the computer device is configured to connect and communicate with an external terminal through a network. The computer program, when executed by the processor, implements a track anomaly detection method.

A person skilled in the art can understand that the structure shown in FIG. 14 is merely a block diagram of a partial structure related to a solution and does not constitute a limitation to the computer device to which the solution in some embodiments is applied. The computer device may include more or fewer components than those shown in the figure, or some components may be combined, or a different component layout may be used.

In some embodiments, a computer device is further provided, including: a memory and a processor. The memory has computer programs stored therein, and the computer programs, when executed by the processor, implement operations in the above method embodiments.

In some embodiments, a computer-readable storage medium is provided, having computer programs stored therein. The computer programs, when executed by a processor, implement operations in the above method embodiments.

In some embodiments, a computer program product is provided, including computer programs. The computer programs, when executed by a processor, implement operations in the above method embodiments.

User information (including, but not limited to, device information of the moving object, user account information, and the like) and data (including, but not limited to, data for analysis, stored data, displayed data, and the like) involved in some embodiments are all information and data authorized by users or fully authorized by all parties, and collection, use, and processing of relevant data should comply with relevant laws, regulations, and standards of relevant countries and areas.

A person of ordinary skill in the art may understand that all or some of procedures of the method in some embodiments may be implemented by a computer program instructing relevant hardware. The computer program may be stored in a non-volatile computer-readable storage medium. When the computer program is executed, the procedures of some embodiments may be implemented. Any reference to a memory, a database, or another medium used in some embodiments can include at least one of a non-volatile or volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM) or an external cache memory. By way of illustration, rather than limitation, RAM may be in various forms, such as a static random access memory (SRAM) or a dynamic random access memory (DRAM), for example The database involved in some embodiments may include at least one of a relational database and a non-relational database. The non-relational database may include a blockchain-based distributed database, or the like, but is not limited thereto. The processor involved in some embodiments may be a central processing unit (CPU), a central processing unit, a graphics processing unit, a digital signal processor, a programmable logic device, a quantum computing-based data processing logic device, or the like, but is not limited thereto.

Technical features of some embodiments may be combined in different manners to form some embodiments. To make description concise, not all possible combinations of the technical features in some embodiments are described. The combinations of these technical features shall be considered as falling within the scope recorded by this specification provided that no conflict exists.

Some embodiments only describe several implementations of this application, which are described specifically and in detail, but cannot be construed as a limitation to the patent scope of this application. For a person of ordinary skill in the art, several transformations and improvements can be made without departing from the idea of this application. These transformations and improvements belong to the protection scope of this application. The protection scope of the patent of this application shall be subject to the appended claims.

What is claimed is:

1. A track anomaly detection method, performed by a computer device, comprising:
acquiring a location to be detected in a moving track generated by a moving object;
determining a target grid to which the location to be detected belongs from a plurality of grids obtained by performing, based on an actual geographic area, gridding processing;
determining at least one historical grid related to the moving object, the at least one historical grid being obtained based on a historical location, located within a preset time range, in the moving track generated by the moving object;
determining, according to a location relationship between the target grid and the at least one historical grid, an anomaly detection result of the moving track; and
transmitting, based on the anomaly detection result indicating the location to be detected is an abnormal location point, information to a terminal, to cause the terminal to display a warning prompt to a user.

2. The track anomaly detection method according to claim 1, further comprising:
determining, based on a road feature in the actual geographic area, at least one grid size; and
performing, according to the at least one grid size, gridding processing on the actual geographic area to obtain the plurality of grids.

3. The track anomaly detection method according to claim 2, wherein the determining the at least one grid size comprises:
dividing, based on the road feature in the actual geographic area, the actual geographic area to obtain at least one feature area;
determining, for the at least one feature area, a theoretical grid distance between two locations based on location sampling being performed at a preset sampling interval; and
determining, according to the theoretical grid distance of the at least one feature area, at least one first grid size corresponding to the at least one feature area, wherein the at least one first grid size corresponds to the actual geographic area.

4. The track anomaly detection method according to claim 3, wherein the determining the theoretical grid distance comprises:
determining, for the at least one feature area, a theoretical moving speed corresponding to the at least one feature area; and
determining, based on location sampling being performed at the preset sampling interval and the moving object moving according to the theoretical moving speed, the theoretical grid distance between the two locations through sampling.

5. The track anomaly detection method according to claim 1, wherein the plurality of grids correspond to a plurality of grid codes, and
wherein the determining the target grid to which the location to be detected belongs comprises:
acquiring location information of the location to be detected;
performing a hash operation on the location information of the location to be detected to obtain a target grid code corresponding to the location to be detected; and
determining, in the plurality of grids, a grid having the target grid code as the target grid to which the location to be detected belongs.

6. The track anomaly detection method according to claim 1, wherein the determining the anomaly detection result comprises:
determining, according to the location relationship between the target grid and the at least one historical grid, whether an association relationship exists between the location to be detected and a first historical location corresponding to the at least one historical grid; and
determining that the moving track has an anomaly based on determining no association relationship exists.

7. The track anomaly detection method according to claim 6, wherein the location relationship between the target grid and the at least one historical grid comprises an equivalent location relationship, an adjacent location relationship, and an independent location relationship, wherein:
the equivalent location relationship represents that the target grid is one of the at least one historical grid;
the adjacent location relationship represents that the target grid is adjacent to one of the at least one historical grid; and
the independent location relationship represents that the target grid is not one of the at least one historical grid and the target grid is not adjacent to each of the at least one historical grid.

8. The track anomaly detection method according to claim 7, wherein the determining whether the association relationship exists comprises:
determining, based on the location relationship between the target grid and the at least one historical grid being the equivalent location relationship, that the association relationship exists between the location to be detected and a second historical location corresponding to a historical grid equivalent to the target grid, the equivalent location relationship representing that the target grid is one of the at least one historical grid.

9. The track anomaly detection method according to claim 7, wherein the determining whether the association relationship exists comprises:
determining, based on the location relationship between the target grid and the at least one historical grid being the adjacent location relationship, that the association relationship exists between the location to be detected and a second historical location corresponding to a historical grid adjacent to the target grid, the adjacent location relationship representing that the target grid is adjacent to one of the at least one historical grid.

10. The track anomaly detection method according to claim 7, wherein the determining whether the association relationship exists comprises:
determining, based on the location relationship between the target grid and the at least one historical grid being the independent location relationship, at least one target historical location from the first historical location corresponding to the at least one historical grid;
determining movement feature data between the location to be detected and the at least one target historical location respectively; and
for the at least one target historical location, determining, based on at least one piece of the movement feature data, whether a first association relationship exists between the location to be detected and the at least one target historical location.

11. A track anomaly detection apparatus, comprising:
at least one memory configured to store computer program code; and
at least one processor configured to read the program code and operate as instructed by the program code, the program code comprising:
acquiring code configured to cause at least one of the at least one processor to determine a location to be detected in a moving track generated by a moving object;
first determining code configured to cause at least one of the at least one processor to determine a target grid to which the location to be detected belongs from a plurality of grids obtained by performing, based on an actual geographic area, gridding processing;
second determining code configured to cause at least one of the at least one processor to determine at least one historical grid related to the moving object, the at least one historical grid being obtained based on a historical location, located within a preset time range, in the moving track generated by the moving object;
detecting code configured to cause at least one of the at least one processor to determine, according to a location relationship between the target grid and the at least one historical grid, an anomaly detection result of the moving track; and
transmitting code configured to cause at least one of the at least one processor to transmit, based on the anomaly detection result indicating the location to be detected is an abnormal location point, information to a terminal, to cause the terminal to display a warning prompt to a user.

12. The track anomaly detection apparatus according to claim 11, further comprising grid processing code configured to cause at least one of the at least one processor to:
determine, based on a road feature in the actual geographic area, at least one grid size; and
perform, according to the at least one grid size, gridding processing on the actual geographic area to obtain the plurality of grids.

13. The track anomaly detection apparatus according to claim 12, wherein the grid processing code is configured to cause at least one of the at least one processor to:
divide, based on the road feature in the actual geographic area, the actual geographic area to obtain at least one feature area;
determine, for the at least one feature area, a theoretical grid distance between two locations based on location sampling being performed at a preset sampling interval; and
determine, according to the theoretical grid distance of the at least one feature area, at least one first grid size corresponding to the at least one feature area, wherein the at least one first grid size corresponds to the actual geographic area.

14. The track anomaly detection apparatus according to claim 13, wherein the grid processing code is configured to cause at least one of the at least one processor to:
determine, for the at least one feature area, a theoretical moving speed corresponding to the at least one feature area; and
determine, based on location sampling being performed at the preset sampling interval and the moving object moving according to the theoretical moving speed, the theoretical grid distance between the two locations through sampling.

15. The track anomaly detection apparatus according to claim 11, wherein the plurality of grids correspond to a plurality of grid codes, and
wherein the first determining code is configured to cause at least one of the at least one processor to:
acquire location information of the location to be detected;
perform a hash operation on the location information of the location to be detected to obtain a target grid code corresponding to the location to be detected; and
determine, in the plurality of grids, a grid having the target grid code as the target grid to which the location to be detected belongs.

16. The track anomaly detection apparatus according to claim 11, wherein the detecting code is configured to cause at least one of the at least one processor to:
determine, according to the location relationship between the target grid and the at least one historical grid, whether an association relationship exists between the location to be detected and a first historical location corresponding to the at least one historical grid; and
determine that the moving track has an anomaly based on determining no association relationship exists.

17. The track anomaly detection apparatus according to claim 16, wherein the location relationship between the target grid and the at least one historical grid comprises an equivalent location relationship, an adjacent location relationship, or an independent location relationship, wherein:
the equivalent location relationship represents that the target grid is one of the at least one historical grid;
the adjacent location relationship represents that the target grid is adjacent to one of the at least one historical grid; and
the independent location relationship represents that the target grid is not one of the at least one historical grid and the target grid is not adjacent to each of the at least one historical grid.

18. The track anomaly detection apparatus according to claim 17, wherein the detecting code is configured to cause at least one of the at least one processor to:
determine, based on the location relationship between the target grid and the at least one historical grid being the equivalent location relationship, that the association relationship exists between the location to be detected and a second historical location corresponding to a historical grid equivalent to the target grid, the equivalent location relationship representing that the target grid is any one of the at least one historical grid.

19. The track anomaly detection apparatus according to claim 17, wherein the detecting code is configured to cause at least one of the at least one processor to:
determine, based on the location relationship between the target grid and the at least one historical grid being the adjacent location relationship, that the association relationship exists between the location to be detected and a second historical location corresponding to a historical grid adjacent to the target grid, the adjacent location relationship representing that the target grid is adjacent to any one of the at least one historical grid.

20. A non-transitory computer-readable storage medium, storing computer code which, when executed by at least one processor, causes the at least one processor to at least:
determine a location to be detected in a moving track generated by a moving object;
determine a target grid to which the location to be detected belongs from a plurality of grids obtained by performing, based on an actual geographic area, gridding processing;
determine at least one historical grid related to the moving object, the at least one historical grid being obtained based on a historical location, located within a preset time range, in the moving track generated by the moving object;
determine, according to a location relationship between the target grid and the at least one historical grid, an anomaly detection result of the moving track; and
transmit, based on the anomaly detection result indicating the location to be detected is an abnormal location point, information to a terminal, to cause the terminal to display a warning prompt to a user.
